(19) United States
(12) Patent Application Publication
(10) Pub. No.: US 2014/0038547 A1
(43) Pub. Date: Feb. 6, 2014

(54) METERED SERVICES

(71) Applicants: Fan Mo, Ottawa (CA); Richard Brunet, Ottawa (CA)

(72) Inventors: Fan Mo, Ottawa (CA); Richard Brunet, Ottawa (CA)

(73) Assignee: Alcatel-Lucent Canada, Inc., Ottawa (CA)

(21) Appl. No.: 13/567,545

(22) Filed: Aug. 6, 2012

(51) Int. Cl. H04W 4/26

(52) U.S. Cl. 455/406

(57) ABSTRACT

Various exemplary embodiments relate to a method and related network node including one or more of the following: determining that a service should be configured for a subscriber; identifying a metering object that is currently applicable to the subscriber, wherein the metering object includes a metering limit and a plurality of actions; selecting a first action of the plurality of actions, wherein the first action includes a first parameter; configuring the service on the PCEN according to the first parameter, wherein configuring the service comprises instructing the PCEN to report usage of the service; and applying the metering limit to usage reported by the PCEN.

### TECHNICAL FIELD

Various exemplary embodiments disclosed herein relate generally to computer networking.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks, leading to a less-than-elegant solution. As seen in second and third generation networks, voice services must be carried over dedicated voice channels and directed toward a circuit-switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications, including the following components: Policy and Charging Rules Function (PCRF); Policy and Charging Enforcement Function (PCEF); and Bearer Binding and Event Reporting Function (BBERF) of the EPC. These technical specifications further provide some guidance as to how these elements interact in order to provide reliable data services and charge subscribers for use thereof.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a policy and charging rules node (PCRN) for providing a metered service via a policy and charging enforcement node (PCEN), the method including: determining that a service should be configured for a subscriber; identifying a metering object that is currently applicable to the subscriber, wherein the metering object includes a metering limit and a plurality of actions; selecting a first action of the plurality of actions, wherein the first action includes a first parameter; configuring the service on the PCEN according to the first parameter, wherein configuring the service includes instructing the PCEN to report usage of the service, and applying the metering limit to usage reported by the PCEN.

Various exemplary embodiments relate to a policy and charging rules node (PCRN) for providing a metered service via a policy and charging enforcement node (PCEN), the PCRN including: a metering object storage configured to store a plurality of metering objects, wherein a first metering object of the plurality of metering objects includes a metering limit and a plurality of actions; a metering object module configured to: receive an indication that a service should be configured for a subscriber, identify the metering object as being applicable to the subscriber, and select a first action of the plurality of actions, wherein the first action includes a first parameter; and a message handler configured to configure the service on the PCEN according to the first parameter, wherein configuring the service includes instructing the PCEN to report usage of the service, wherein the message handler is further configured to apply the metering limit to usage reported by the PCEN.

Various exemplary embodiments relate to a non-transitory machine-readable storage medium encoded with instructions for execution by a policy and charging rules node (PCRN) for providing a metered service via a policy and charging enforcement node (PCEN), the medium including: instructions for determining that a service should be configured for a subscriber; instructions for identifying a metering object that is currently applicable to the subscriber, wherein the metering object includes a metering limit and a plurality of actions; instructions for selecting a first action of the plurality of actions, wherein the first action includes a first parameter; instructions for configuring the service on the PCEN according to the first parameter, wherein configuring the service includes instructing the PCEN to report usage of the service; and instructions for applying the metering limit to usage reported by the PCEN.

Various embodiments are described wherein the service includes at least one of an IP-CAN session, a wireline session, a bearer, and a service data flow (SDF).

Various embodiments are described wherein the first parameter includes at least one of a policy charging and control (PCC) rule name and a quality of service (QoS) value.

Various embodiments are described wherein: determining that the service should be configured includes receiving a request to establish the service for the subscriber; and selecting the first action includes identifying a default action of the plurality of actions.

Various embodiments additionally include, after configuring the service on the PCEN according to the first parameter: receiving usage data for the service; identifying an applicable usage threshold of the metering object based on the usage data wherein the applicable usage threshold is associated with a second action and the second action includes a second parameter; and configuring the service on the PCEN according to the second parameter.

Various embodiments additionally include generating a policy and charging control (PCC) rule based on the first parameter, wherein configuring the service on the PCEN further includes transmitting the PCC rule to the PCEN.

Various embodiments are described wherein instructing the PCEN to report usage of the service includes transmitting a monitoring key specified by the metering object to the PCEN.

### BRIEF DESCRIPTION OF THE DRAWINGS

In order to better understand various exemplary embodiments, reference is made to the accompanying drawings, wherein:

FIG. 1 illustrates an exemplary network environment for providing a metered service;

FIG. 2 illustrates an exemplary policy and charging rules node (PORN);

FIG. 3 illustrates an exemplary set of metering objects;

FIG. 4 illustrates an exemplary method for providing a metered service; and

FIG. 5 illustrates an exemplary message exchange for establishing and updating a metered service.

To facilitate understanding, identical reference numerals have been used to designate elements having substantially the same or similar structure or substantially the same or similar function.

### DETAILED DESCRIPTION

Various services in an LTE environment may be implemented according to various parameters such as quality of service (QoS) and/or charging parameters. Network operators may wish to change these parameters occasionally based on service usage. For example, after an established service has transferred 10 GB of data, the network operator may wish to reduce the QoS provided for that service. Currently, such a change may involve completely reprovisioning the service using the new QoS parameters. This approach, however, may utilize excessive time and system resources and may be prone to error. Accordingly, there is a need for a system and method for providing and modifying services without complete reprovisioning.

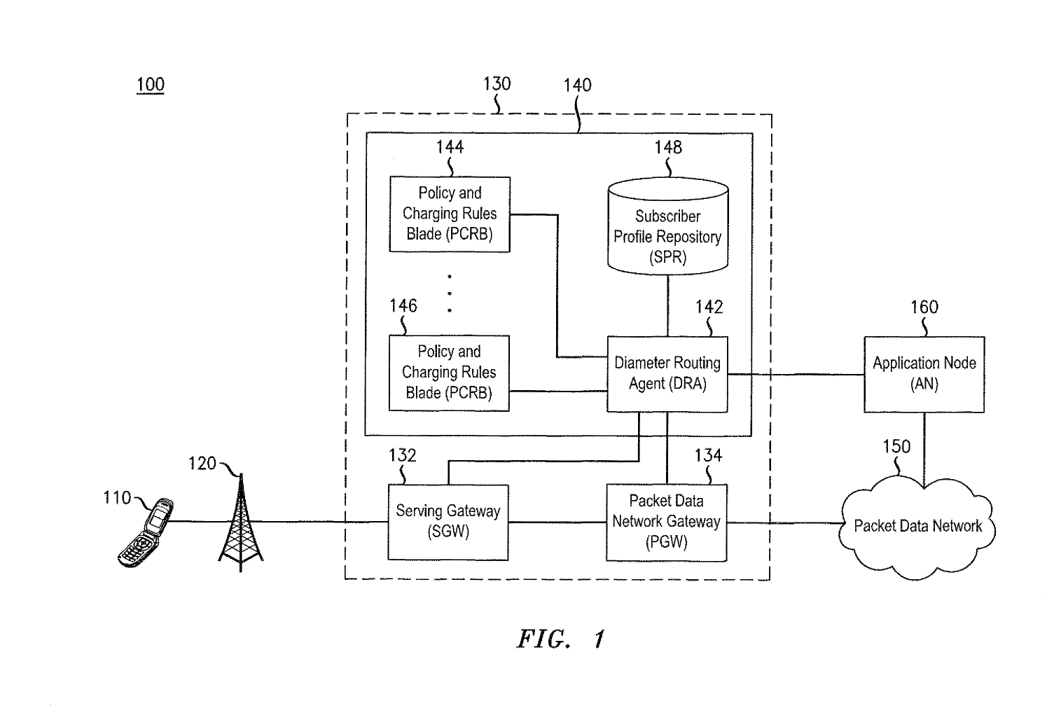

FIG. 1 illustrates an exemplary network environment 100 for providing a metered service. The exemplary network environment 100 may be a subscriber network for providing various services. In various embodiments, the subscriber network 100 may be a public land mobile network (PLMN). The subscriber network 100 may be a telecommunications network or other network for providing access to various services. The subscriber network 100 may include user equipment 110, a base station 120, an evolved packet core (EPC) 130, a packet data network 150, and an application node (AN) 160.

The user equipment 110 may be a device that communicates with the packet data network 150 for providing the end-user with a data service. Such data service may include, for example, voice communication, text messaging, multimedia streaming, and/or Internet access. More specifically, in various exemplary embodiments, the user equipment 110 is a personal or laptop computer, wireless email device, cell phone, tablet, television set-top box, or any other device capable of communicating with other devices via the EPC 130.

The base station 120 may be a device that enables communication between the user equipment 110 and the EPC 130. For example, the base station 120 may be a base transceiver station such as an evolved nodeB (eNodeB) as defined by the relevant 3GPP standards. Thus, the base station 120 may be a device that communicates with the user equipment 110 via a first medium, such as radio waves, and communicates with the EPC 130 via a second medium, such as Ethernet cable. The base station 120 may be in direct communication with the EPC 130 or may communicate via a number of intermediate nodes (not shown). In various embodiments, multiple base stations (not shown) may be present to provide mobility to the user equipment 110. Note that in various alternative embodiments, the user equipment 110 may communicate directly with the EPC 130. In such embodiments, the base station 120 may not be present.

The evolved packet core (EPC) 130 may be a device or network of devices that provides the user equipment 110 with gateway access to the packet data network 140. The EPC 130 may further charge a subscriber for use of provided data services and ensure that particular quality of experience (QoE) standards are met. Thus, the EPC 130 may be implemented, at least in part, according to the relevant 3GPP standards. The EPC 130 may include a serving gateway (SGW) 132, a packet data network gateway (PGW) 134, and a session control device 140.

The serving gateway (SGW) 132 may be a device that provides gateway access to the EPC 130. The SGW 132 may be one of the first devices within the EPC 130 that receives packets sent by the user equipment 110. Various embodiments may also include a mobility management entity (MME) (not shown) that receives packets prior to the SGW 132. The SGW 132 may forward such packets toward the PGW 134. The SGW 132 may perform a number of functions such as, for example, managing mobility of the user equipment 110 between multiple base stations (not shown) and enforcing particular quality of service (QoS) characteristics for each flow being served. In various implementations, such as those implementing the Proxy Mobile IP standard, the SGW 132 may include a Bearer Binding and Event Reporting Function (BBERF). In various exemplary embodiments, the EPC 130 may include multiple SGWs (not shown) and each SGW may communicate with multiple base stations (not shown).

The packet data network gateway (PGW) 134 may be a device that provides gateway access to the packet data network 140. The PGW 134 may be the final device within the EPC 130 that receives packets sent by the user equipment 110 toward the packet data network 140 via the SGW 132. The PGW 134 may include a policy and charging enforcement function (PCEF) that enforces policy and charging control (PCC) rules for each service data flow (SDF). Therefore, the PGW 134 may be a policy and charging enforcement node (PCEN). The PGW 134 may include a number of additional features such as, for example, packet filtering, deep packet inspection, and subscriber charging support. The PGW 134 may also be responsible for requesting resource allocation for unknown application services.

The session control device 140 may be a device that provides various management or other functions within the EPC 130. For example, the session control device 140 may provide a Policy and Charging Rules Function (PCRF) and, as such, may constitute a Policy and Charging Rules Node (PCRN). In various embodiments, the session control device 140 may include an Alcatel Lucent 5780 Dynamic Services Controller (DSC). The session control device 140 may include a Diameter routing agent (DRA) 142, a plurality of policy and charging rules blades (PCRBs) 144, 146, and a subscriber profile repository 148.

The DRA 142 may be an intelligent Diameter routing agent. As such, the DRA 142 may operate as a relay agent, proxy agent, and/or redirect agent for various receive messages. Such routing may be performed with respect to incoming and outgoing messages, as well as messages that are internal to the session control device. For example, the DRA 142 may receive a message from the PGW 134 and forward the request to an appropriate PCRB 144, 146.

The policy and charging rules blades (PCRBs) 144, 146 may each be a device or group of devices that receives requests for application services, generates PCC rules, and/or provides PCC rules to the PGW 134 or other PCENs (not shown). The PCRBs 144, 146 may each implement a PCRF and, as such, may each independently constitute a PCRN. Thus, the session control device 140 and each of the PCRBs 144, 146 may constitute PCRNs. The PCRBs 144, 146 may be in communication with AN 160 according to an Rx Diameter application via the DRA 142. As described in further detail below with respect to the AN 160, the PCRBs 144, 146 may receive an application request in the form of an Authentication and Authorization Request (AAR) from the AN 160. Upon receipt of an AAR, the PCRB 144, 146 may generate at least one new PCC rule for fulfilling the application request.

The PCRBs 144, 146 may also be in communication with the SGW 132 and the PGW 134 according to a Gxx and a Gx Diameter application, respectively, via the DRA 142. A PCRB 144, 146 may receive an application request in the form of a credit control request (CCR) from the SGW 132 or the PGW 134. As with an AAR, upon receipt of a CCR, the PCRBs 144, 146 may generate at least one new PCC rule for fulfilling the application request. In various embodiments, the AAR and the CCR may represent two independent application requests to be processed separately, while in other embodiments, the AAR and the CCR may carry information regarding a single application request and the PCRB 144, 146 may create at least one PCC rule based on the combination of the AAR and the CCR. In various embodiments, the PCRBs 144, 146 may be capable of handling both single-message and paired-message application requests.

Upon creating a new PCC rule or upon request by the PGW 134, a PCRB 144, 146 may provide a PCC rule to the PGW 134 according to the Gx application. In various embodiments, such as those implementing the proxy mobile IP (PMIP) standard for example, the PCRB 144, 146 may also generate QoS rules. Upon creating a new QoS rule or upon request by the SGW 132, the PCRB 144, 146 may provide a QoS rule to SGW 132 according to the Gxx application.

The subscriber profile repository (SPR) 148 may be a device that stores information related to subscribers to the subscriber network 100. Thus, the SPR 148 may include a machine-readable storage medium such as read-only memory (ROM), random-access memory (RAM), magnetic disk storage media, optical storage media, flash-memory devices, and/or similar storage media. The SPR 148 may be a component of one or more of the PCRBs 144, 146 or may constitute an independent node within the EPC 130 or the session control device 140. Data stored by the SPR 138 may include subscriber information such as identifiers for each subscriber, bandwidth limits, charging parameters, and subscriber priority.

The packet data network 150 may be any network for providing data communications between the user equipment 110 and other devices connected to the packet data network 150, such as the AN 160. The packet data network 150 may further provide, for example, phone or Internet service to various user devices in communication with packet data network 150. In various embodiments, the packet data network 150 may include the Internet.

The application node (AN) 160 may be a device that provides a known application service to the user equipment 110. Thus, the AN 160 may be a server or other device that provides, for example, a video streaming or voice communication service to the user equipment 110. The AN 160 may further be in communication with the PCRBs 144, 146 of the EPC 130 according to the Rx application. When the AN 160 is to begin providing known application service to the user equipment 110, the AN 160 may generate an application request message, such as an authentication and authorization request (AAR) according to the Diameter protocol, to notify a PCRB 144, 146 that resources should be allocated for the application service. This application request message may include information such as an identification of the subscriber using the application service, an IP address of the subscriber, an APN for an associated IP-CAN session, or an identification of the particular service data flows that must be established in order to provide the requested service.

As will be understood, various Diameter applications may be established within the subscriber network 100 and supported by the DRA 142. For example, an Rx application may be established between the AN 160 and each of PCRBs 144, 146. As another example, an Sp application may be established between the SPR 148 and each of PCRBs 144, 146. As yet another example, an S9 application may be established between one or more of the PCRBs 144, 146 and a remote device implementing another PCRF (not shown). As will be understood, numerous other Diameter applications may be established within the subscriber network 100.

As will be described in greater detail below, in establishing various metered services, such as IP-CAN sessions, bearers, and service data flows (SDFs), the PCRBs 144, 146 may be adapted to utilize a metering object. Upon receiving a request, a PCRB 144, 146 may identify an applicable metering object based on the requesting subscriber and the context of the request. The metering object may include a default action to be taken in establishing the new metered service. For example, the default action may specify a PCC rule to be installed or various QoS parameters to be provided for an IP-CAN session. As used herein, the term “parameter” may refer to any data or value that may be used to configure a service such as, for example, PCC rules, QoS values, and charging metrics. As time goes on, other metering objects may become applicable to the service, and the default actions of those metering objects may specify alternative parameters and/or rules to be utilized. Further, as the PGW 134 reports data usage, usage thresholds specified by the metering objects may be met and thereby specify additional actions to be take.

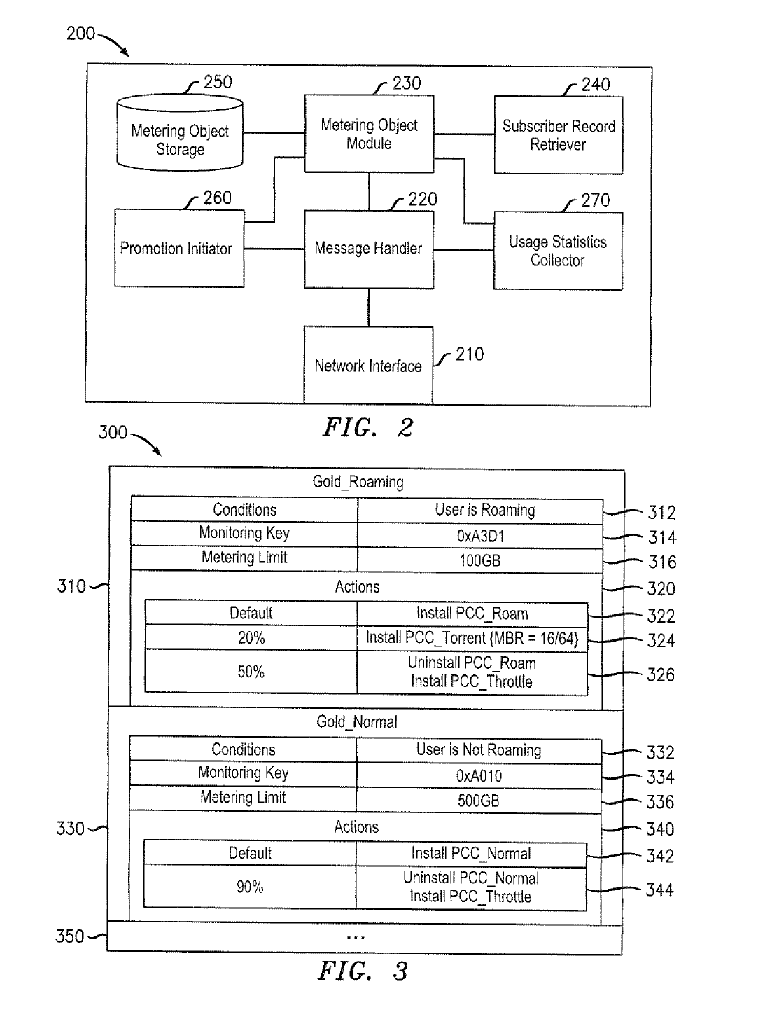

FIG. 2 illustrates an exemplary policy and charging rules node (PCRN) 200. The PCRN 200 may be a standalone device or a component of a larger system. For example, the PCRN 200 may correspond to one or more of the PCRBs 144, 146 of the subscriber network 100. The PCRN 200 may include a network interface 210, a message handler 220, a metering object module 230, a subscriber record retriever 240, a metering object storage 250, a promotion initiator 260, and a usage statistics collector 270. It will be apparent that various components of the PCRN 200 may constitute abstractions and may utilize other hardware devices. For example, the components may utilize one or more common processors. As used herein, the term “processor” will be understood to encompass microprocessors, field-programmable gate arrays (FPGAs), application-specific integrated circuits (ASICs), and/or other similar hardware devices.

The network interface 210 may include an interface including hardware or executable instructions encoded on a machine-readable storage medium configured to communicate with other devices. For example, the network interface 210 may include an Ethernet or TCP/IP interface. In various embodiments, the network interface 210 may include multiple physical ports. The network interface 210 may also implement a Diameter stack.

The message handler 220 may include hardware and/or executable instructions encoded on a machine-readable medium configured to receive, process, and transmit various Diameter messages via the network interface 210. For example, the message handler 220 may be configured to receive and identify a message requesting the establishment of a new service. In processing the establishment request, the message handler 220 may instruct the metering object module 230 to retrieve and evaluate a metering object. The message handler 220 may then take action based on the outcome of this evaluation. Processing of the establishment request may include additional steps such as, for example, invoking a rules engine (not shown) to generate a dynamic PCC rule or determine other operating parameters. After processing the establishment message, the message handler 220 may construct and transmit, via the network interface 210, a message to establish or to reject the requested service. For example, the message handler 220 may transmit a CCA installing a PCC rule at a PCEN.

The metering object module 230 may include hardware and/or executable instructions encoded on a machine-readable medium configured to retrieve and evaluate a metering object. Each subscriber may be associated with a set of potentially applicable metering objects. For example, a network operator may specify, in each subscriber record, what metering objects could be applicable for the subscriber. To determine which subset of metering objects stored in the metering object storage 250 could possibly apply, the metering object module 230 may request a subscriber record from the subscriber record retriever 240. After receiving the subscriber record and determining which subset of metering objects may apply, the metering object module 230 may proceed to determine which metering object of the subset actually applies to the current context.

Each metering object may include one or more conditions for determining whether the metering object applies to a current context. The metering object module 230 may evaluate these conditions and select one metering object to be further evaluated. Each metering object may further include a default action and/or a number of additional actions associated with usage thresholds. Each action may specify one or more tasks to be performed with respect to a metered service such as, for example, installation of a PCC rule or specification of other parameter values. The metering object module 230 may select an appropriate action and pass the action back to the message handler 220 for performance of the specified tasks. In the case of establishing a new service, the metering object module 230 may simply select the default action because no usage may have been recorded for the service yet.

The subscriber record retriever 240 may include hardware and/or executable instructions encoded on a machine-readable medium configured to retrieve a subscriber record from an SPR (not shown). Thus, the subscriber record retriever 240 may receive one or more subscriber identifiers from the metering object module 230 identifying the subscriber record to be retrieved. The subscriber record retriever 240 may then communicate with an SPR according to the Sp application to retrieve the record for use by the metering object module 230.

The metering object storage 250 may be any machine-readable medium capable of storing one or more metering objects. Accordingly, the metering object storage 250 may include a machine-readable storage medium such as read-only memory (ROM), random-access memory (RAM), magnetic disk storage media, optical storage media, flash-memory devices, and/or similar storage media. Exemplary contents for the metering object storage 250 will be described in greater detail below with respect to FIG. 3.

At times specified by a network operator, it may be desirable to apply a promotion to existing services, thereby altering one or more parameters of the service. For example, at 7 pm on Fridays, the network operator may wish to apply a “free nights and weekends” promotion to existing voice services. Application of such a promotion may involve setting a charging metric to “0 cents/min” for one or more existing services. Additionally or alternatively, a network operator may manually initiate promotions for selected services.

The promotion initiator 260 may include hardware and/or executable instructions encoded on a machine-readable medium configured to initiate operator-specified promotions. As such, the promotion initiator 260 may be configured with various days and times at which promotions should be applied to various types of services. When the current day and time matches a configured promotion, the promotion initiator 260 may instruct the metering object module 230 to reevaluate one or more services. The promotion initiator 260 may also instruct the message handler 220 to work with the metering object module 230 to effect any appropriate service changes. Additionally or alternatively, an operator may manually initiate a promotion via a user interface (not shown) in communication with the promotion initiator 260. The promotion initiator 260 may provide context information such as, for example, and identification of the promotion to be applied. The metering object module 230 may then use this context information along with other existing context information for the service to select and evaluate a monitoring object, as previously described. The additional and/or updated context information may lead to the selection and evaluation of a different monitoring object. When performing actions associated with a newly-applicable monitoring object, the message handler 220 may be configured to “roll back” any actions performed based on the previous monitoring object. For example, the message handler may uninstall a previously-installed PCC rule and/or revert a QoS attribute to a previous value.

At various times, PCENs may also transmit update messages for existing services. The message handler 220 may be further configured to process update messages. An update message may specify changed service conditions that may warrant reevaluation of a monitoring object. For example, an update message may indicate that a user device is now roaming, in which case a network operator may wish to limit QoS and/or increase a charging rate. Upon receiving such an update message, the message handler 220 may instruct the metering object module 230 to select and evaluate a metering object, as previously described. The update message may alter context information associated with the service and may lead to the selection and evaluation of a different monitoring object. When performing actions associated with a newly-applicable monitoring object, the message handler 220 may be configured to “roll back” any actions performed based on the previous monitoring object. For example, the message handler may uninstall a previously-installed PCC rule and/or revert a QoS attribute to a previous value.

Some update messages may include usage statistics. In various embodiments, the message handler 220 may transmit a monitoring key for various services that may, in turn, be used by the PCEN to track and report usage. Upon receiving an update including usage statistics, the message handler 220 may be configured to forward the monitoring key and usage statistics to the usage statistics collector 270.

The usage statistics collector 270 may include hardware and/or executable instructions encoded on a machine-readable medium configured to store usage statistics for use by the metering object module 230. As such, the usage statistics collector 270 may include a machine-readable storage medium configured to store usage statistics in association with a service and/or monitoring key. The metering object module 230 may access these usage statistics when evaluating a monitoring object. Based on the usage statistics, the metering object module 230 may determine that one or more usage thresholds have been met and that the associated action should be performed rather than the default action.

FIG. 3 illustrates an exemplary set of metering objects 300. The set of metering objects 300 may be stored, for example, in the metering object storage 250 of the exemplary PCRN 200. The set of metering objects 300 may be stored as, for example, a table in a database stored in the metering object storage 250. Alternatively, the set of metering objects 300 could be a series of linked lists, an array, or a similar data structure. Thus, it should be apparent that the set of metering objects 300 may be an abstraction of the underlying data; any data structure suitable for storage of this data may be used.

The set of metering objects 300 may include a number of metering objects 310, 330, 350. As shown in exemplary metering object 310, each metering object may include a set of conditions 312 for determining whether a metering object applies to a current context. For example, set of conditions 312 may indicate that metering object 310 may be applicable when a user is roaming. Each metering object may also specify a monitoring key that the PCEN should use in monitoring and reporting data usage for a service and a metering limit for evaluating the reported data usage by the PCRN. For example, monitoring object 310 may include a monitoring key field 314 that indicates that the monitoring key “0xA3D1” should be used for monitoring purposes and a metering limit field 316 the indicates that a metering limit of “100 GB” should be applied.

As further illustrated by exemplary monitoring object 310, each monitoring object may also include a set of actions 320 specifying actions to be taken at different usage thresholds. For example, the set of actions 320 may indicate that, as a default action 322, a predefined PCC rule named “PCC_Roam” should be installed. The set of actions 320 may also specify that, when the usage threshold “20%” has been met, a “provisioned” PCC rule names “PCC_Torrent” should be installed. The usage threshold may be net when the total reported usage surpasses the specified threshold. Thus, the exemplary “20%” threshold may be met when 20 GB (20% of the 100 GB metering limit 316) of usage has been reported by the PCEN for the monitoring key “0xA3D1” 314. A provisioned PCC rule may be a template PCC rule or may otherwise accept values to be “plugged in” to the rule. In the example action 324, the rule PCC_Torrent is given maximum bitrate values of 16 kbps upstream and 64 kbps downstream. Yet another action 326 may indicate that, when a usage threshold of “50%” is met, the rule “PCC_Roam” should be uninstalled while the predefined rule “PCC_Throttle” should be installed. Thus, as illustrated, each action may specify multiple tasks to be performed.

As another example, monitoring object 330 may include a conditions field 332 specifying applicability when a user is not roaming, a monitoring key field 334 specifying that monitoring key “0xA010” should be used when the monitoring object 330 is active, and a metering limit field 336 specifying that a metering limit of “500 GB” should be applied to the reported data usage. The set of actions 340 may specify that a default action 342 indicates that a predefined rule named “PCC_Normal” should be installed for the service. Another action 344 may specify that, when the usage threshold of “90%” has been met, the PCC rule “PCC_Normal” should be uninstalled by the rule “PCC_Throttle” should be installed.

It will be apparent that, while the exemplary metering objects 310, 330 may be applicable in providing service data flows, additional metering objects (not shown) may be applicable to session and/or bearer level monitoring. Various modifications for such session and/or bearer level metering objects will be apparent.

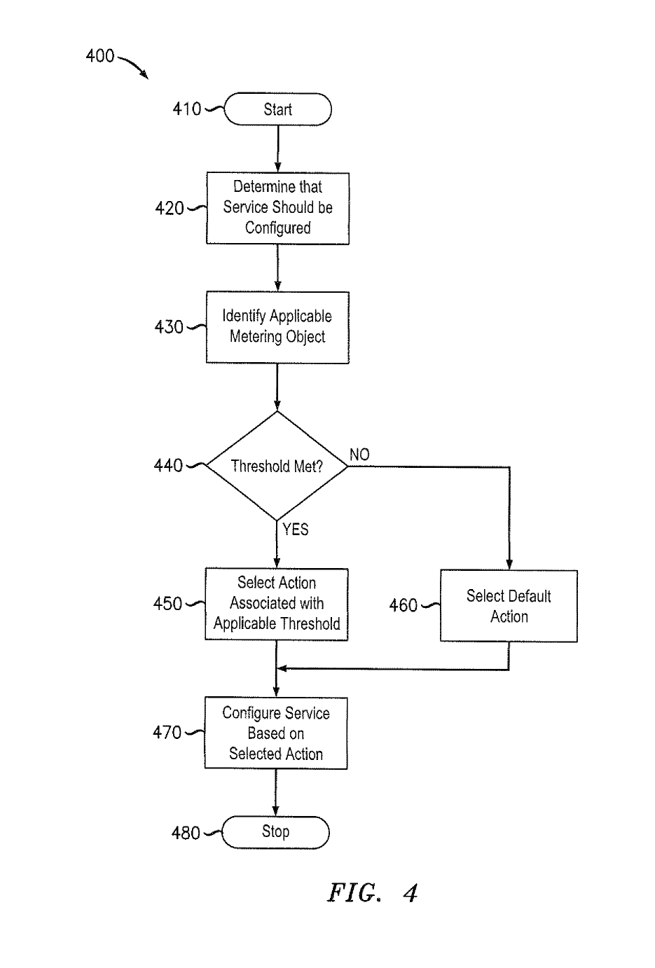

FIG. 4 illustrates an exemplary method 400 for providing a metered service. The method 400 may be performed by the components of a PCRN such as, for example, the message handler 220 and metering object module 230 of the exemplary PCRN 200.

The method 400 may begin in step 410 and proceed to step 420 where the PCRN 200 may determine that a service should be configured. This determination may be made based on, for example, the receipt of a request to establish a service, the receipt of an update message, or the determination that a promotion should be applied to a service. Next, in step 430, the PCRN 200 may identify an applicable metering object. For example, the PCRN 200 may first retrieve a subscriber record to identify which metering objects might apply. Next, the PCRN 200 may evaluate conditions associated with the identified metering objects to select one applicable metering object.

The PCRN 200 may then begin to evaluate the selected metering object by determining, in step 440, whether any threshold associated with the metering object has been met. For example, the PCRN 200 may evaluate usage statistics reported for the service, if any, as compared to any usage thresholds defined by the metering object. Such evaluation may involve application of the metering limit to the usage data such as, for example, when the usage thresholds are defined relative to the metering limit. If a threshold has been met, the PCRN 200 may, in step 450, select the action associated with the applicable threshold by the monitoring object. If no threshold has been met, the PCRN 200 may instead, in step 460, select a default action defined by the monitoring object. The PCRN 200 may then, in step 470, configure the service based on the selected action. For example, the PCRN 200 may configure one or more session-level parameters or install one or more PCC and/or QoS rules for the service. The PCRN may also instruct a PCEN to use a monitoring key specified by the monitoring object. This instruction may include transmitting the monitoring key to the PCEN or, if the same monitoring key has already been installed at the PCEN, refraining from uninstalling the monitoring key. The method 400 may then proceed to end in step 480. Thereafter, the PCRN may periodically receive usage reports for the service and apply the relevant metering limit to the usage reported by, for example, identifying any newly applicable thresholds according to step 450.

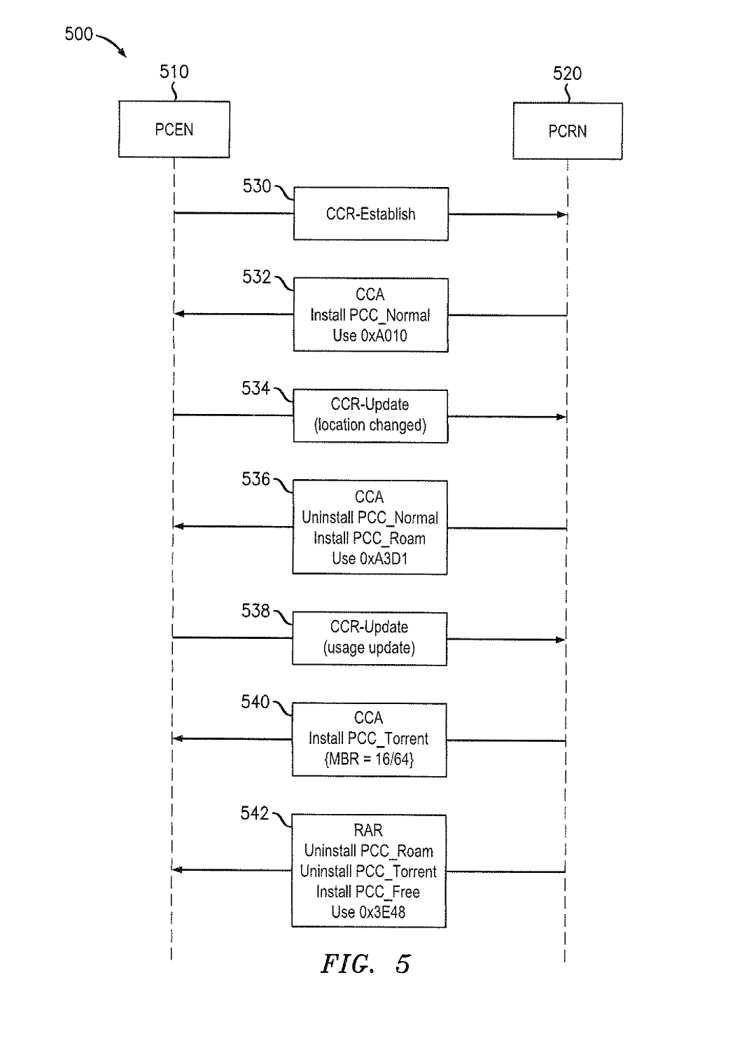

FIG. 5 illustrates an exemplary message exchange 500 for establishing and updating a metered service. The message exchange 500 may occur between a PCEN 510 and a PCRN 520. The PCEN 510 may correspond, for example, to the PGW 134 of the exemplary subscriber network 100. The PCRN 520 may correspond to a PCRB 144, 146 of the exemplary subscriber network 100 and/or the exemplary PCRN 200.

The message exchange may begin when PCEN 510 transmits a CCR 530 requesting the establishment of a new service. The PCRN 520 may process this message by determining that, for the associated user, “Gold” level monitoring objects may be applicable. For example, a subscriber profile associated with the user may identify monitoring objects 310, 330 as potentially applicable. The PCRN 520 may further determine, based on available context information, that the user is not roaming and, as such, the monitoring object “Gold_Normal” 330 may be applicable. Because no usage statistics may yet be logged for the new service, the PCRN 520 may select the default action 342. The PCRN 520 may then transmit a CCA 532 to install the PCC rule “PCC_Normal” and monitoring key “0xA010.”

At some point, the user equipment 110 may change location so that the user is now roaming. In response, the PCEN 510 may transmit a CCR 534 including an update for the service. It will be understood that, due to various events such as a location change, a different device may transmit the CCR 534 (and other messages) to the PCRN 510. For example, a different PCEN (not shown) or a visited PCRN (not shown) may transmit the CCR 534. The update may indicate the changed location. The PORN 520 may process the CCR 534 by determining that the “Gold_Roaming” metering object may now be applicable because the condition 312 has been met. The PCRN 520 may select the default action 322 because no usage statistics have yet been logged for the new monitoring key, “0xA3D1.” The PORN 520 may generate and transmit a CCA to roll back the previous CCA 532 and to install the PCC rule “PCC_Roam” and monitoring key “0xA3D1.”

The PCEN 510 may later transmit another CCR 538 including an update. The CCR 538 may specify a current measured usage for the monitoring key “0xA3D1.” For example, the CCR 538 may specify that 25 GB of data transfer has been observed. Based on the updated usage statistics, the PORN 520 may determine that the usage threshold “20%” has been met and that the action 324 is applicable. The PORN 520 may then transmit a CCA 540 to install the rule “PCC_Torrent” with the specified maximum bitrate values.

Next, the PORN 520 may determine that a promotion should be applied to the service. The PORN 520 may locate a metering object associated with the promotion for the user and select a default action of the new metering object. Based on this metering object, the PORN 520 may transmit a RAR 542 to apply the promotion. The RAR 542 may roll back the previous actions by uninstalling the PCC rules “PCC_Roam” and “PCC_Torrent.” The RAR 542 may also install the PCC rule “PCC_Free” and the new monitoring key “0x3E48.”

According to the foregoing, various embodiments enable the efficient and reliable provisioning and updating of metered services. By including default actions in metering objects, a service may be provisioned and updated throughout the course of service without reprovisioning the service after each update. Additional benefits will be apparent in view of the foregoing.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a policy and charging rules node (PORN) for providing a metered service via a policy and charging enforcement node (PCEN), the method comprising:
determining that a service should be configured for a subscriber;
identifying a metering object that is currently applicable to the subscriber, wherein the metering object includes a metering limit and a plurality of actions;
selecting a first action of the plurality of actions, wherein the first action includes a first parameter;
configuring the service on the PCEN according to the first parameter, wherein configuring the service comprises instructing the PCEN to report usage of the service; and
applying the metering limit to usage reported by the PCEN.

2. The method of claim 1, wherein the service comprises at least one of an IP-CAN session, a wireline session, a bearer, and a service data flow (SDF).

3. The method of claim 1, wherein the first parameter comprises at least one of a policy charging and control (FCC) rule name and a quality of service (QoS) value.

4. The method of claim 1, wherein:
determining that the service should be configured comprises receiving a request to establish the service for the subscriber; and
selecting the first action comprises identifying a default action of the plurality of actions.

5. The method of claim 1, further comprising, after configuring the service on the PCEN according to the first parameter:
receiving usage data for the service;
identifying an applicable usage threshold of the metering object based on the usage data, wherein the applicable usage threshold is associated with a second action and the second action includes a second parameter; and
configuring the service on the PCEN according to the second parameter.

6. The method of claim 1, further comprising generating a policy and charging control (PCC) rule based on the first parameter, wherein configuring the service on the PCEN further comprises transmitting the PCC rule to the PCEN.

7. The method of claim 1, wherein instructing the PCEN to report usage of the service comprises transmitting a monitoring key specified by the metering object to the PCEN.

8. A policy and charging rules node (PCRN) for providing a metered service via a policy and charging enforcement node (PCEN), the PCRN comprising:
a metering object storage configured to store a plurality of metering objects, wherein a first metering object of the plurality of metering objects includes a metering limit and a plurality of actions;
a metering object module configured to:
receive an indication that a service should be configured for a subscriber,
identify the metering object as being applicable to the subscriber, and
select a first action of the plurality of actions, wherein the first action includes a first parameter; and
a message handler configured to configure the service on the PCEN according to the first parameter, wherein configuring the service comprises instructing the PCEN to report usage of the service,
wherein the message handler is further configured to apply the metering limit to usage reported by the PCEN.

9. The PCRN of claim 8, wherein the service comprises at least one of an IP-CAN session, a wireline session, a bearer, and a service data flow (SDF).

10. The PCRN of claim 8, wherein the first parameter comprises at least one of a policy charging and control (PCC) rule name and a quality of service (QoS) value.

11. The PCRN of claim 8, further comprising a network interface, wherein:
the message handler is further configured to:
receive, via the network interface, a request to establish the service for the subscriber, and
send the indication to the metering object module that the service should be configured for a subscriber; and
the metering object module, in selecting the first action is configured to identify a default action of the plurality of actions.

12. The PCRN of claim 8, further comprising a usage statistics collector configured to receive, after the message handler configures the service on the PCEN according to the first parameter, usage data for the service, wherein:
the metering object module is further configured to identify an applicable usage threshold of the metering object based on the usage data, wherein the applicable usage threshold is associated with a second action and the second action includes a second parameter; and
the message handler is further configured to configure the service on the PCEN according to the second parameter.

13. The PORN of claim 8, further comprising a rule generator configured to generate a policy and charging control (PCC) rule based on the first parameter, wherein the message handler, in configuring the service on the PCEN, is configured to transmit the PCC rule to the PCEN.

14. The PCRN of claim 8, wherein the message handler, in instructing the PCEN to report usage of the service, is configured to transmit a monitoring key specified by the metering object to the PCEN.

15. A non-transitory machine-readable storage medium encoded with instructions for execution by a policy and charging rules node (PORN) for providing a metered service via a policy and charging enforcement node (PCEN), the medium comprising:
instructions for determining that a service should be configured for a subscriber;
instructions for identifying a metering object that is currently applicable to the subscriber, wherein the metering object includes a metering limit and a plurality of actions;
instructions for selecting a first action of the plurality of actions, wherein the first action includes a first parameter;
instructions for configuring the service on the PCEN according to the first parameter, wherein configuring the service comprises instructing the PCEN to report usage of the service; and
instructions for applying the metering limit to usage reported by the PCEN.

16. The non-transitory machine-readable storage medium of claim 15, wherein the service comprises at least one of an IP-CAN session, a wireline session, a bearer, and a service data flow (SDF).

17. The non-transitory machine-readable storage medium of claim 15, wherein the first parameter comprises at least one of a policy charging and control (PCC) rule name and a quality of service (QoS) value.

18. The non-transitory machine-readable storage medium of claim 15, wherein:
the instructions for determining that the service should be configured comprise instructions for receiving a request to establish the service for the subscriber; and
the instructions for selecting the first action comprise instructions for identifying a default action of the plurality of actions.

19. The non-transitory machine-readable storage medium of claim 15, further comprising instructions for, after configuring the service on the PCEN according to the first parameter:
receiving usage data for the service;
identifying an applicable usage threshold of the metering object based on the usage data, wherein the applicable usage threshold is associated with a second action and the second action includes a second parameter; and
configuring the service on the PCEN according to the second parameter.

20. The non-transitory machine-readable storage medium of claim 15, further comprising instructions for generating a policy and charging control (PCC) rule based on the first parameter, wherein configuring the service on the PCEN further comprises transmitting the PCC rule to the PCEN.
